(19) United States
(12) Patent Application Publication
(10) Pub. No.: US 2001/0022906 A1
(43) Pub. Date: Sep. 20, 2001

(54) IMAGE FORMING APPARATUS

(76) Inventors: HIROYUKI KAWAI, KAWASAKI-SHI (JP); SHINJI SATO, TOKYO (JP); AKIRA NAGAHARA, KAWASAKI-SHI (JP); SACHIO SASAKI, KAWASAKI-SHI (JP); MITSURU SATO, KAWASAKI-SHI (JP); TAKEFUMI TAKAHASHI, TOKYO (JP); MASAHIRO WANOU, KAWASAKI-SHI (JP); MASAO KONISHI, KAWASAKI-SHI (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 08/220,205

(22) Filed: Mar. 30, 1994

(30) Foreign Application Priority Data
Sep. 24, 1993 (JP) 5-261604

(51) Int. Cl. G03G 15/08

(52) U.S. Cl. 399/262

(57) ABSTRACT

Disclosed is an image forming apparatus which will form images in both a horizontal position and an upright position. This image forming apparatus comprises a rotary endless latent image carrier; an image forming unit for forming an electrostatic latent image on the latent image carrier; a developing unit for developing the electrostatic latent image on the latent image carrier with a powdery developer; a toner supplementing mechanism, attached to the developing unit with inclination to a gravitational direction of the apparatus, for supplementing toners to the developing unit; and a transfer unit for transferring the developed image on the latent image carrier to a sheet. With this design, the apparatus can stably supply toners to the developing unit, regardless of the position in which the apparatus is set.

### BACKGROUND OF THE INVENTION

1. Field of the Invention

The present invention relates to an image forming apparatus which will perform an image forming operation both in a horizontal position and an upright position.

2. Description of the Related Art

In image recording apparatuses, such as a copying machine, a printer and a facsimile, a latent image forming apparatus like an electrophotographic apparatus is used due to the popularity of image recording on normal sheets of paper. Such an image forming apparatus forms an electrostatic latent image on a photosensitive drum or the like. Then, the electrostatic latent image on the photosensitive drum is developed with a powder developer to provide a visible image. The developed image on the photosensitive drum is then transferred on a sheet, and the sheet is then separated from the photosensitive drum. Thereafter, the developed image on the sheet is fixed.

For example, Japanese Unexamined Patent Publication No. 323125/1992 discloses an image forming apparatus which will operate in an upright position as well as in a horizontal position. The toner supplementing direction of the toner cartridge of this image forming apparatus is the direction of gravity. When this apparatus is set upright, therefore, the toner supplementing direction becomes perpendicular to the gravitational direction, so that toners may not be supplemented smoothly in this position.

If a toner supplementing mechanism is provided for supplementing toners, toners are likely to remain in the toner cartridge, resulting in inefficient usage of resources.

### SUMMARY OF THE INVENTION

It is therefore a primary object of the present invention to provide an image forming apparatus which will stably supplement toners in both a horizontal position and an upright position.

It is another object of the present invention to provide an image forming apparatus which will reduce the residual toners in a toner supplementing mechanism as much as possible to ensure efficient usage of toners.

To achieve the foregoing and other objects in accordance with the purpose of the present invention, according to the invention, an image forming apparatus for forming an image on a sheet in both an upright position and a horizontal position, comprises a rotary endless latent image carrier; an image forming unit for forming an electrostatic latent image on the latent image carrier; a developing unit for developing the electrostatic latent image on the latent image carrier with a powdery developer; a toner supplementing mechanism, attached to the developing unit with inclination to a gravitational direction of the apparatus, for supplementing toners to the developing unit; and a transfer unit for transferring the developed image on the latent image carrier to a sheet.

According to the present invention, the toner supplementing mechanism is attached to the developing unit with inclination to the gravitational direction. Whether the apparatus is set in a horizontal position or an upright position, therefore, the gravity will cause the toners in the toner supplementing mechanism to fall into the developing unit by the dead weight. In both horizontal and upright positions, this image forming apparatus will stably supplement toners and will accomplish stable image forming.

Other features and advantages of the present invention will become readily apparent from the following description taken in conjunction with the accompanying drawings.

### BRIEF DESCRIPTION OF THE DRAWINGS

The accompanying drawings, which are incorporated in and constitute a part of the specification, illustrate a presently preferred embodiment of the invention, and together with the general description given above and the detailed description of the preferred embodiments given below, serve to explain the principles of the invention.

FIG. 1 is a structural diagram of one embodiment of the present invention;

FIG. 2 is a diagram showing the apparatus in FIG. 1 in a horizontal position;

FIG. 3 is a diagram showing the apparatus in FIG. 1 in an upright position;

FIG. 4 is a cross section of an image forming mechanism shown in FIG. 1;

FIG. 5 is an explanatory diagram of the image forming mechanism shown in FIG. 4;

FIG. 6 is a structural diagram of a developing unit in the structure in FIG. 1;

FIG. 7 is a cross section showing the essential portions of the developing unit in FIG. 6;

FIG. 8 is a diagram showing the developing unit in FIG. 6 in an upright position;

FIGS. 9A and 9B are diagrams for explaining the operation of the developing unit in FIG. 6;

FIG. 10 is a characteristic chart of the image forming operation of the present invention;

FIG. 11 is a diagram for explaining the angle at which a toner cartridge is installed according to the present invention;

FIGS. 12A and 12B are structural diagrams of a modification of the present invention; and

FIGS. 13A and 13B are structural diagrams of another modification of the present invention.

### DETAILED DESCRIPTION OF THE PREFERRED EMBODIMENT

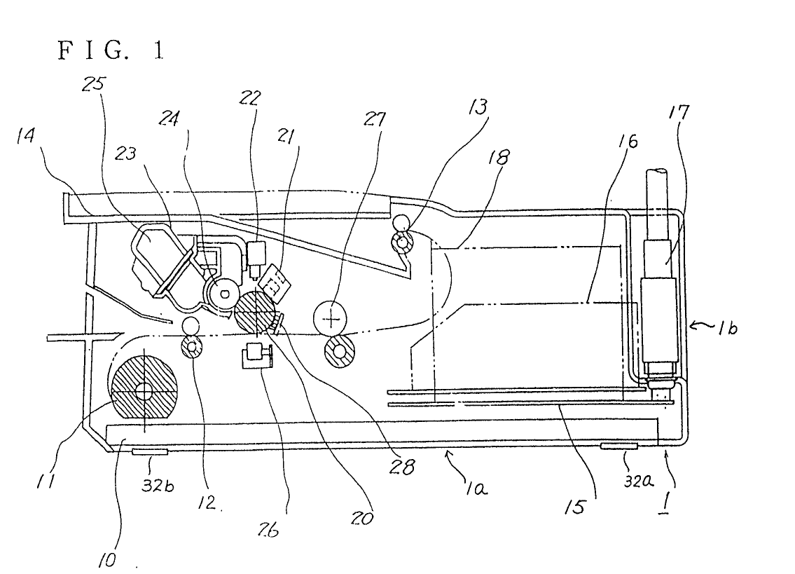

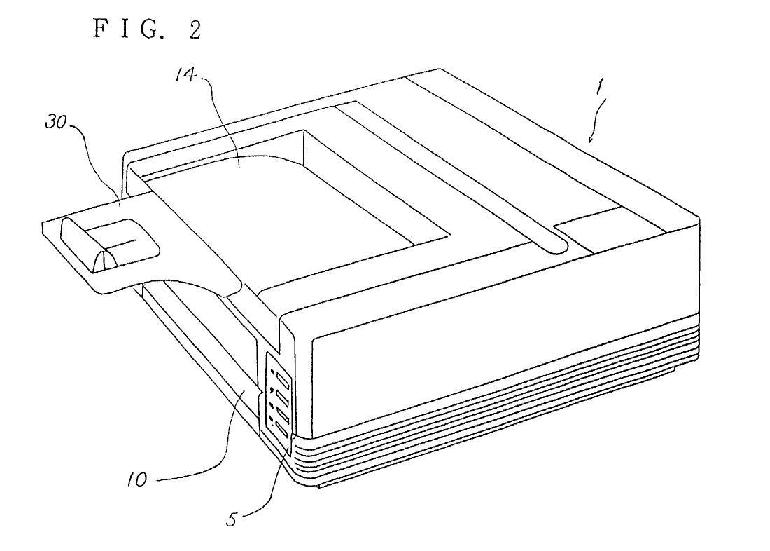

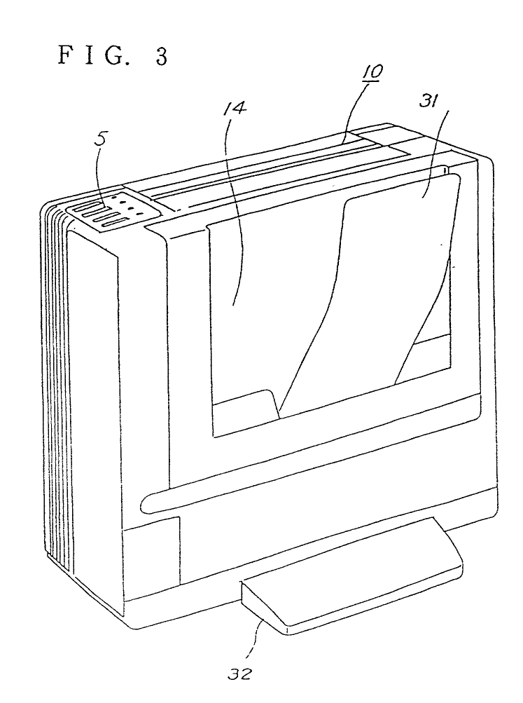

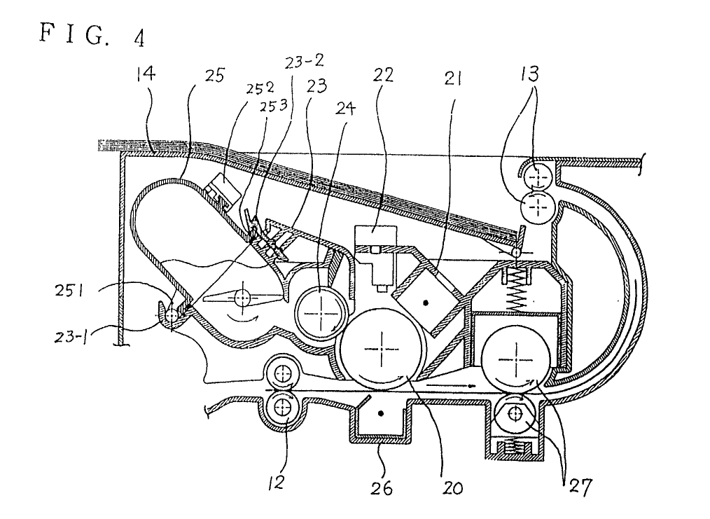

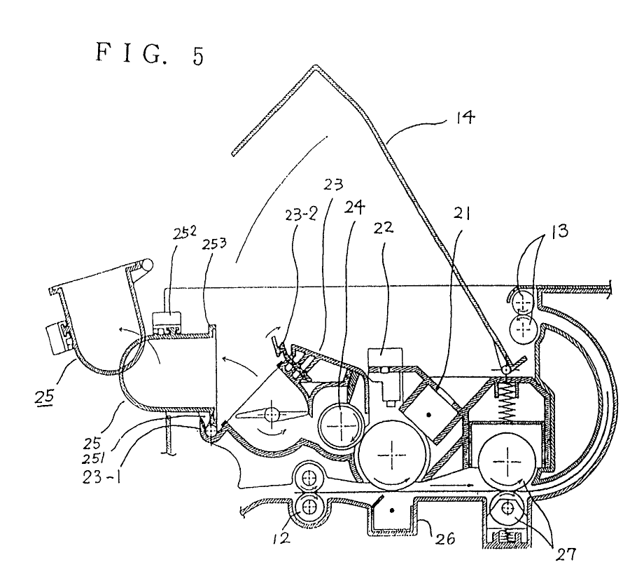

FIG. 1 is a structural diagram of an image forming apparatus according to one embodiment of the present invention, FIG. 2 is a diagram showing the apparatus in FIG. 1 in a horizontal position, FIG. 3 is a diagram showing the apparatus in FIG. 1 in an upright position, FIG. 4 is a cross section of an image forming mechanism shown in FIG. 1, and FIG. 5 is an explanatory diagram of the image forming mechanism shown in FIG. 4. The diagrams illustrate an electrophotographing printer as the image forming apparatus.

Referring to FIGS. 1 and 4, a photosensitive drum 20 is an aluminum drum on which a functionally separate organic photosensitive body is coated about 20 microns thick. This photosensitive drum 1 has an outside diameter of 24 mm and rotates at a peripheral speed of 25 mm/s in the counterclockwise direction indicated by the arrow. A precharger 21 is a non-contact type charger constituted of a Scolotron. This precharger 21 uniformly charges the surface of the photosensitive drum 20 to −580 V.

An optical unit 22 exposes the photosensitive drum 20 to image light to form an electrostatic latent image. This optical unit 22 in use is an LED optical system which has an LED array combined with a self-focus array. This optical unit 22 exposes the photosensitive drum 20 to image light to form an electrostatic latent image thereon. The potential of the latent image portion becomes −50 to −100 V.

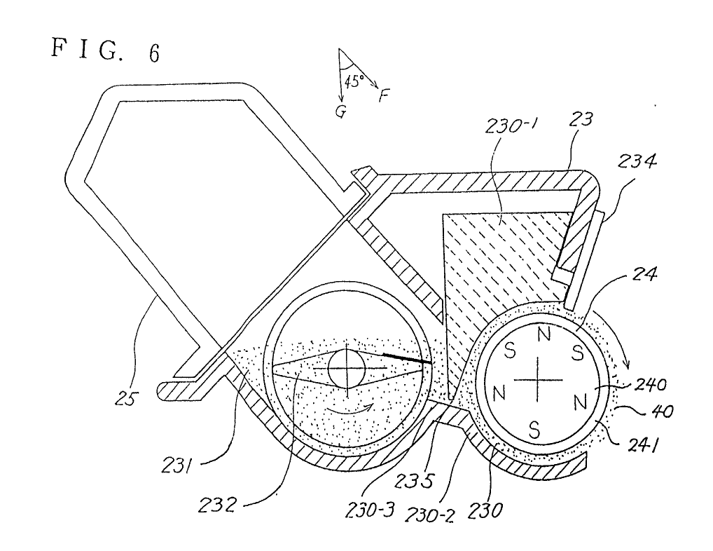

A developing unit 23 supplies charged toners to the electrostatic latent image on the photosensitive drum 20 to provide a visible toner image. This developing unit 23 will be discussed later with reference to FIG. 6 and subsequence drawings. Developing rollers 24 of the developing unit 23 feed a developer to the photosensitive drum 20. A toner cartridge 25 is filled with magnetic toners and attached with the developing unit 23 exchangeably. The toner cartridge 25 supplies magnetic toners to the developing unit 23, and is exchangeable in an toner empty status. That is, the toner cartridge 25 serves as toner supplementing means.

A transfer unit 26 is constituted of a corona discharger. This transfer unit 26 electrostatically transfers the toner image on the photosensitive drum 20, onto a sheet. A voltage of +3 KV to +6 KV is applied to a corona wire from a power supply so that electric charges will be generated by corona discharging. The back of the sheet is charged with the electric charges so that the toner image on the photosensitive drum 20 is transferred on the sheet P. It is desirable that this power supply be a constant current source which supplies a constant amount of charges to the sheet to thereby reduce the deterioration of the transfer efficiency due to the environmental conditions.

A fixing unit 27 comprises a heat roller having a halogen lamp incorporated therein as a heat source, and heat rollers (backup rollers), and heats the sheet to fix the toner image on the sheet.

A uniform distribution brush 28 is a conductive brush, which, when in contact with the photosensitive drum 20, prevents the concentration of residual toners on the photosensitive drum 20 and uniformly distributes them over the drum 20 to facilitate the toner collection in the developing unit 23. An AC voltage is applied to this uniform distribution brush 28 to remove the residual toners off the photosensitive drum 20 and place the toners again on the drum 20 to properly distribute the residual toners. Further, a voltage equal to or greater than the voltage needed to start discharging may be applied to the brush 28 to de-electrify the photosensitive drum 20, in which case a residual positive image formed by the residual charges will be eliminated.

As shown in FIG. 1, a sheet cassette 10, which retains sheets, is detachably attached to the printer. This sheet cassette 10 is installed at the lower portion of the printer and can be attached to or detached from the printer from the front side of the printer, which is on the left-hand side in FIG. 1. Pickup rollers 11 serve to pick up sheets from the sheet cassette 10. Resist rollers 12 align the leading edge of a picked sheet when it abuts on the rollers 12 before feeding the sheet to the transfer unit 26. Discharge rollers 13 discharge the sheet after image fixing onto a stacker 14. The stacker 14 is provided on the top of the printer to receive the discharged sheet.

A printed circuit board 15 has a printer controller installed thereon. A power supply 16 supplies power to the individual sections of the printer. An interface connector 17 is connected to an external cable at one end and is inserted in the printer at the other end to be connected to the connector of the printed circuit board 15. An optional board 18 has another type of emulator circuit, font memory, etc. installed thereon.

The operation of this embodiment will be described below. After the surface of the photosensitive drum 20 is evenly charged to −580 V by the Scolotron charger 21, image exposure is performed by the LED optical system 22 to form an electrostatic latent image with the background portion charged to −580 V and the exposed or printing portion charged to −50 to −100 V, on the photosensitive drum 20. A developing bias voltage (−450 V) is applied to sleeves 241 of the developing rollers 24 of the developing unit 23. Therefore, the electrostatic latent image is developed by magnetic polymerization toners, which have previously been stirred with a carrier to have been charged negatively, in the developing unit 23, yielding a toner image.

Meanwhile, a sheet is picked up from the sheet cassette 10 by the pickup rollers 11 and its leading edge is aligned by the resist rollers 12 before being sent to the transfer unit 26. The toner image on the photosensitive drum 20 is transferred onto the sheet by electrostatic force by the transfer unit 26. The toner image on the sheet is fixed by the fixing unit 27, and is fed along an U-shaped feeding path to be discharged on the stacker 14 by the discharge rollers 13.

The efficiency of transferring the toner image on a sheet is not 100%, and some toners remain on the photosensitive drum 20. To remove the residual toners, a well-known cleanerless process (disclosed in, for example, “Cleanerless Laser Printer Using One-component Non-magnetic Developing System,” Electrophotographic Institute Report, vol. 30, no. 3, pp. 293-301) is employed.

In this cleanerless process, no cleaner is used and residual toners after image transfer are collected by the developing unit 23. Accordingly, the residual toners after image transfer can be used again in a printing process. The aforementioned uniform distribution brush 28 of a conductive type is used in place of a cleaner in this cleanerless process.

In the recording process, the residual toners on the photosensitive drum 20 after image transfer are distributed by the uniform distribution brush 28. Thereafter, the surface of the photosensitive drum 20 with toners sticking thereon is evenly charged by the corona charger 21, image exposure is performed by the LED optical system 22 and image developing is conducted at the same time as the collection of the residual toners after image transfer by the developing unit 23.

The uniform distribution brush 28 distributes the toners concentrating locally to reduce the amount of toners per unit area, so that the toner collection by the developing unit 23 becomes easier. As an additional advantage, the brush 28 suppresses the effect of filtering the ion shower of the corona charger 21 by the toners and the image filtering effect by the toners in the image exposing process.

The key point of this recording process is to collect the toners on the photosensitive drum 20 at the same time as the developing process is carried out. This will be further discussed below with reference to the case where the photosensitive drum 20 and the toners are both charged negatively. The surface potential of the photosensitive drum 20 is set to −580 V by the charger 21, and the exposed portion whose potential has dropped by image exposure will have a reduced potential of 0 to minus several tens of volts, forming an electrostatic latent image. At the time of developing the latent image, a developing bias voltage (e.g., −450 V), which is almost the middle of the surface potential and the potential of the latent image, is applied to the developing rollers 24 of the developing unit 23.

In the developing process, the negatively charged toners sticking on the developing rollers 24 are adhered to the electrostatic latent image on the photosensitive drum 20, forming a toner image, by an electric field that is created by the developing bias voltage and the potential of the latent image. In the cleanerless process, the residual toners after image transfer which have been distributed over the photosensitive drum 20 in the uniform distribution process by the distribution brush 28 are collected from the photosensitive drum 20 by the developing rollers 24 by the electric field, generated by the surface potential and latent image potential.

In the above cleanerless process, (1) no mechanism for disposing toners is required, thus contributing to making the printer compact, (2) no space required to store the disposed toners, (3) all the toners will be used in printing, which is economical, (4) no toners will be disposed of, which is friendly to the environmental preservation, (5) no cleaner, which scrapes the surface of the photosensitive drum 20 to shorten the service life thereof, is used to thereby elongate the life of the drum 20.

Because of no cleaner used and other reasons, this printer can be designed very compact and will be easily placed on the top of a desk as a personal-usage printer. Further, this printer can be placed in a horizontal position with the sheet cassette 10 extending in parallel to a siting surface, as shown in FIG. 2. In this diagram, an operation panel 5 indicates the status of the printer and serves to instruct the operation of the printer. A sheet guide 30 is provided at the distal end of the stacker 14. This sheet guide 30 serves to press and align the leading edge the sheet that is to be discharged on the stacker 14. In this embodiment, the sheet cassette 10 can be attached to and detached from the front side of the printer. In addition, the sheet is discharged to the front of the printer.

When the printer is being used in the horizontal position, four rubber stands 32a and 32b, each of which is provided at each corner of a bottom surface 1a of the printer, are used and function s a stand member. The bottom surface 1a of the printer is the sitting surface when the printer is used in the horizontal position.

As shown in FIG. 3, image formation is possible in an upright position where the interface connector 17 of the printer in FIG. 1 is provided on the siting surface 1b, and the sheet cassette 10 is set upright to be perpendicular to the siting surface 1b. The sitting surface 1b is a rear surface of the printer 1. This reduces the siting space further. Under this condition, the developing unit 23 is located above the photosensitive drum 20. At this time, a sheet presser 31 may be provided on the stacker 14 to press sheets to be discharged on the stacker so that the sheets will not fall down even when the printer is placed upright. If a stand 32 is provided at the siting surface side of the printer as illustrated, the printer even in an upright position stay stably.

As a stand provided at the sitting surface 1b, rubber stands which are fixed at each corner of the sitting surface 1b of the printer, may be used.

Further, the bottom surface and the rear surface themselves may be used as a stand member.

Even without the cleanerless process, as the precharger 21 and the transfer unit 26 are constituted of a non-contact type discharger, the toners on the photosensitive drum 20 will not stick on those units, so that the uniform charging and image transfer can be accomplished stably.

As shown in FIG. 4, the toner cartridge is detachably attached to a topper hopper 230 (which will be discussed later with reference to FIG. 6) of the developing unit 23. A shaft 251 is provided on one side of this toner cartridge 25 and a projection 253 is provided on the other side. A handle 252 is provided on the side surface of the toner cartridge 25. The toner hopper 230 of the developing unit 23 is provided with a shaft support block 23-1 and a hook 23-2.

To detach the toner cartridge 25 as the toner supplementing means from the developing unit 23, the user opens the cover which constitutes the stacker 14 first as shown in FIG. 5. Next, the user manipulates the hook 23-2 to disengage it from the projection 253 of the toner cartridge 25. Then, the user should hold the toner cartridge 25 with the handle 252 and rotate the cartridge 25 around the shaft 251 supported on the shaft support block 23-1. Then, the user should remove the shaft 251 of the toner cartridge 25 from the shaft support block 23-1 to detach the toner cartridge 25.

A new toner cartridge 25 has a toner opening between the shaft 251 and the projection 253 sealed with a tape. The user should engage the shaft 251 of the toner cartridge 25 with the shaft support block 23-1, and engage the projection 253 of the toner cartridge 25 with the hook 23-2 in the reverse procedures to set the cartridge 25. Then, the user should pull the sealing tape across to pen the toner opening.

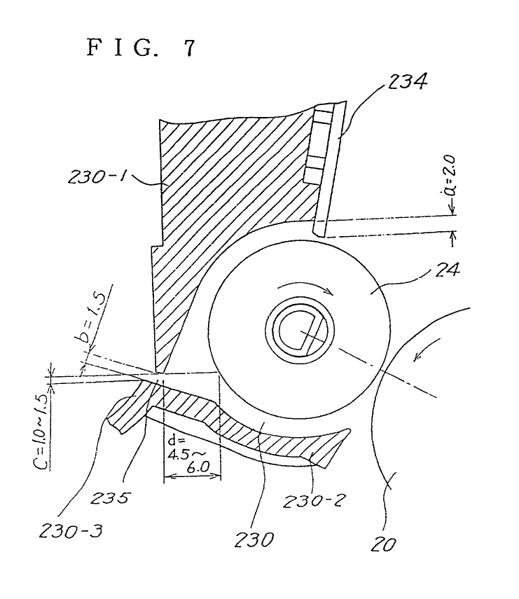

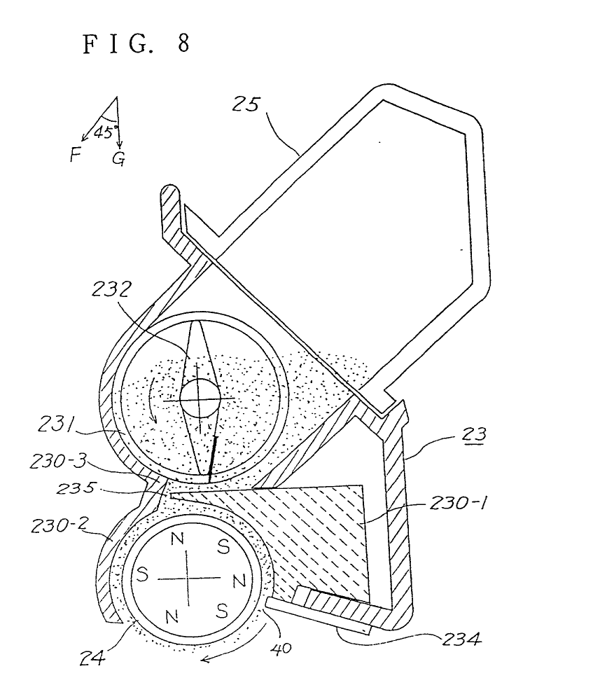

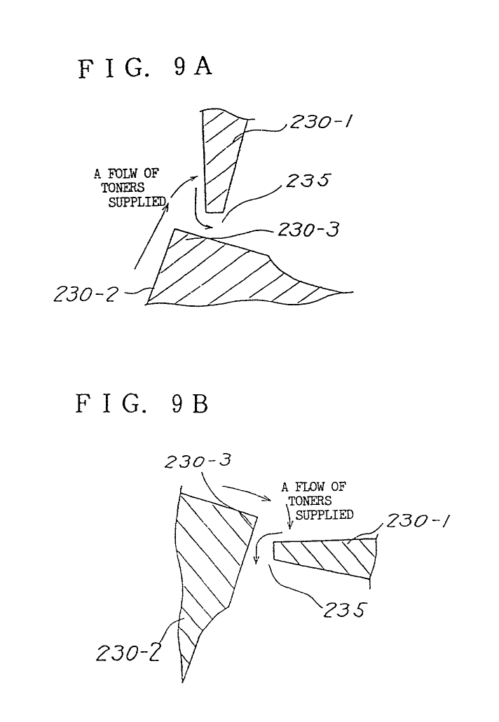

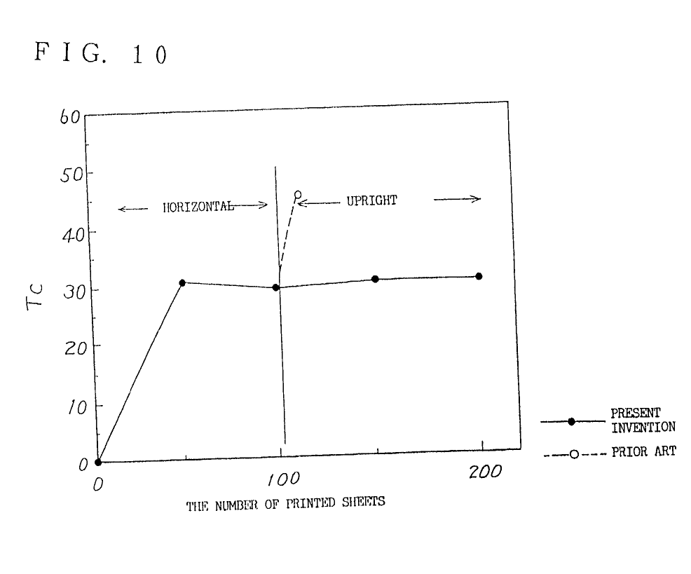

FIG. 6 is a structural diagram of the developing unit in FIG. 1, FIG. 7 is a cross section showing the essential portions of the developing unit in FIG. 6, FIG. 8 is a diagram showing the developing unit in FIG. 6 in an upright position, FIGS. 9A and 9B are diagrams for explaining the toner supply operation, and FIG. 10 is a characteristic chart of the image forming operation of the present invention.

As shown in FIG. 6, the developing rollers 24 has the aforementioned metal sleeve 241 and a plurality of magnets 240 disposed inside the sleeve 241. The developing rollers 24 feed a magnetic developer (to be described later) by the rotation of the sleeve 241, with the magnets 240 inside the sleeve 241 secured. The developing rollers 24 are 16 mm in diameter and rotate at a speed (75 mm/s) three times faster than the peripheral speed of the photosensitive drum 20.

A developing room 230 is formed around the developing rollers 24. The developing room 230 is filled with a 1.5-component developer, which is a mixture of a magnetic carrier and magnetic toners. This developing room 230 is defined by an upper partition member 230-1 and a bottom 230-2, and has a constant volume.

When a constant amount of a magnetic carrier is supplied to the developing room 230, the amount of the magnetic toners in this room 230 also becomes constant. As the amount of the developer in the developing room 230 is constant, the toner density becomes constant when the used magnetic toners are supplemented from a toner hopper 231. This can eliminate the need to control the toner density. In other words, the toner density is automatically controlled within a predetermined range by supplementing the amount of the magnetic carrier, which is equivalent to the control point for the toner density, into the developing room 230.

Because the developer is always fully present around the developing rollers 24 in this developing room 230, even with the printer placed upright, the developer in the developing room 230 will not concentrate at some part, thus preventing insufficient supply of the developer to the developing rollers 24.

The magnetic carrier in the developer is a magnetite carrier of an average particle size of 35 microns. The magnetic toners are polymerization toners of an average particle size of 7 microns. The polymerization toners have a uniform particle size and have a sharp particle distribution, so that adhesion between the sheet and the toner image on the photosensitive drum 20 becomes uniform in the transfer process. Accordingly, the electric field in the transfer section becomes uniform, thus improving the transfer efficiency more than the conventional pulverizing method. The transfer efficiency of the pulverized toners is 60 to 90% while the transfer efficient of the polymerization toners is 90% or above. Although the proper toner density of the toners is 5 to 60% by weight, it was set to 30% by weight in this embodiment.

A doctor blade 234 serves to adjust the supply amount of the developer by the developing rollers 24 so that the developer will not be supplied excessively or insufficiently to the electrostatic latent image on the photosensitive drum 20. The adjustment is performed by the gap between the edge of the doctor blade 234 and the surfaces of the developing rollers 24; the gap is normally adjusted to about 0.1 to 1.0 mm.

The toner hopper 231 is filled only with magnetic toners and has a supply roller 232 inside. The rotation of the supply roller 232 supplies the toners to the developing room 230.

The toners supplied to the developing room 230 are stirred therein and rubbed against the carrier to be charged to a predetermined potential of a given polarity by the developer supplying force of the sleeves of the developing rollers 24, the magnetic force of the developing rollers 24 and the developer regulating performance of the doctor blade 234. In this embodiment, the toners are charged negatively to control the charging systems of the carrier and the toners.

Further, the gap between the partition member 230-1 and the developing rollers 24 at the upstream of the blade 234 is set smaller than the tips of the bristles of the magnetic brush formed on the developing rollers 24, as shown in FIG. 7. In this example, the gap a is set to 2.0 mm as shown in FIG. 7. Accordingly, the magnetic brush on the developing rollers 24 is restricted by the partition member 230-1 and receives force by the rotation of the developing rollers 24. This increases the stirring of the developer in the developing room 230, ensuring a stable amount of toner charging even within a high toner-density range.

This gap is uniformly set around the developing rollers 24, so that the same charging effect will be obtained regardless of the upright position or horizontal position of the printer.

A toner supply passage 235, which is defined by the distal end of the partition member 230-1 and the bottom 230-2, is provided between the toner hopper 231 and the developing room 230. The width b of the toner supply passage 235 is 1.5 mm as apparent from FIG. 7. The toners in the toner hopper 231 are supplied along the toner supply passage 235 to the developing room 230.

The bottom 230-2 that defines the developing room 230 has a projection 230-3 protruding from the toner hopper 231 in the toner supply passage 235. The bottom 230-2 has an inclined face extending upward from the side of the photosensitive drum 20. The gap c between the distal end of the projection 230-2 and the distal end of the partition member 230-1 is set to 1.0 to 1.5 mm as shown in FIG. 7. That is, the bottom 230-2 is inclined by this amount. In addition, the distance d between the distal end of the partition member 230-1 and the developing rollers 24 is set to 4.5 to 6.0 mm.

As shown in FIG. 6, the angles of both walls of the toner cartridge 25 and the toner hopper 231, F, are set to about 45 degrees with respect to the gravitational direction G, ensuring the angle of the toner flow to 45 degrees. Even with the printer set upright, therefore, the toners will be supplied smoothly as will be described later.

The operation of this developing unit will be described below. FIG. 6 shows the state of the developing unit when the printer is set in a horizontal position, as shown in FIG. 2, with the angles F of the walls of the toner cartridge 25 and the toner hopper 231 are set to about 45 degrees with respect to the gravitational direction G. Therefore, the toners flow toward the bottom of the toner hopper 231 to be smoothly supplied to the supply roller 232.

In this horizontal position, the toners flow toward the bottom in the toner hopper 231 due to gravitation, so that the supply roller 232 scrapes off the toners at the bottom of the toner hopper 231. At this time, the toners lifted by the supply roller 232 temporarily abut on the partition member 230-1 by the projection 230-3 of the bottom 230-2 and then enter the toner supply passage 235, as shown in FIG. 9A. As a result, only the toners supplied by the toner supply roller 232 enter the toner supply passage 235. The toner abutting portion of the partition 230-1 serves as a buffer so that the force of the toner supply roller 232 will not directly influence the toner supply passage 235. This prevents excessive supply of the toners and allows just the amount of toners needed to be supplied to the developing room 230.

As the bottom 230-2 is tilted with respect to the rotational direction of the developing rollers 24 in this case, the magnetic brush of the developing rollers 24 after passing the photosensitive drum 20 and the carrier that has escaped the brush will not leak into toner hopper 231 along the toner supply passage 235 through the bottom 230-2. It is therefore possible to prevent the amount of the starter carrier in the developing room 230 from decreasing and accomplish stable image development with the 1.5-component developer.

In the state of the developing unit shown in FIG. 8 with the printer set upright as in FIG. 3, the angles F of the walls of the toner cartridge 25 and toner hopper 231 are also set to about 45 degrees with respect to the gravitational direction G. Even in this upright position, therefore, the toners can be smoothly supplied to the toner supply roller 231.

At this time, the toners stay on the toner hopper side of the partition member 230-1 and will easily fall off the toner supply passage 235 into the developing room 230 as shown in FIG. 8. But, the projection 230-3 of the bottom 230-2 restricts the falling of the toners from the toner supply passage 235 as shown in FIG. 9B so that the toners would hardly drop. In other words, the supply of the toners is dependent on the rotational force of the toner supply roller 232.

As shown in FIG. 9B, the toners pressed by the toner supply roller 232 temporarily abut on the partition member 230-1 by the projection 230-3 of the bottom 230-2 and then enter the toner supply passage 235. As a result, only the toners supplied by the toner supply roller 232 enter the toner supply passage 235, and the toner abutting portion of the partition 230-1 serves as a buffer, so that the force of the toner supply roller 232 will not directly act to supply the toners. This prevents excessive supply of the toners and allows just the amount of toners needed to be supplied to the developing room 230.

This means that the performance of supplying the toners to the developing room 230 does not change, regardless of whether the printer is set in a horizontal position or in an upright position. Irrespective of whether the printer is set in a horizontal position or in an upright position, therefore, the toner density in the developing room 230 does not change, thus preventing a variation in image density.

In other words, the toners to be supplied to the developing room 230 mostly come from the toner supply roller 232, thus accomplishing toner supply which is not affected by the toners' fluidity in the gravitational direction. Even if the siting direction of the printer changes, therefore, the amount of toner supply will not change, thus ensuring a stable developing operation.

With the printer in an upright position, the developer may drop from the developing unit 23. Since the magnetic two-component developer is used, however, the developer is held sticking on the developing rollers by the magnetic force so that the developer hardly drops even when the printer is set upright. When the magnetic carrier and the magnetic toners are used, particularly, the carrier and toners are both held by the magnet rollers of the developing rollers 24, further preventing the developer from dropping and ensuring stable image development even when the printer is in an upright position.

FIG. 10 presents a characteristic diagram showing a change in toner density Tc when printing is executed first with the printer set in a horizontal position and then with the printer in an upright position.

First, the printer was set in a horizontal position, a predetermined amount of start carrier was placed in the developing room 230 of the developing unit 23 and the developing unit 23 was then activated to conduct printing. The toners are gradually supplied to the developing room 230 from the toner hopper 231, so that as the number of printouts increases, the toner density increases. When the developing room 230 become full with the carrier and toners, the toner density was 30% by weight. Thereafter, even when the number of printouts increased, the toner density did not change.

Under this condition, the printer was then set upright and printing was conducted. The toner density remained the same as that of the previous case of the printer in a horizontal position. When the printer using the conventional 1.5-component developing unit, disclosed in Japanese Unexamined Patent Publication No. 252686/1991, is set upright, the toner density increased as indicated by a while circle. That is, the toner density changed and the image density changed between the horizontal position and the upright position. This proves the stable toner supply of the present invention. Regardless of whether the printer is set in a horizontal or upright position, images will be formed without a variation in image density. The present invention will therefore provide an image forming apparatus which can be set in a horizontal position as well as in an upright position with the same printing quality.

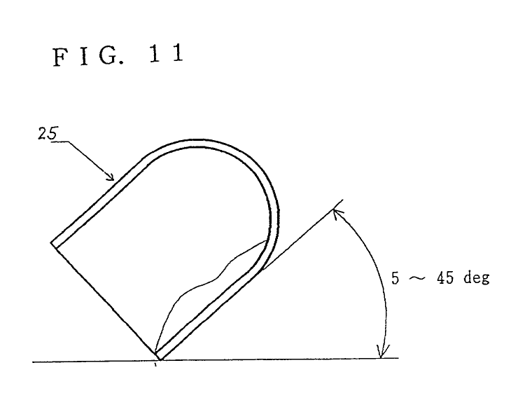

A description will now be given of the angles of the walls of the toner cartridge 25 and the toner hopper 231. FIG. 11 is a diagram for explaining the angle of the walls of the toner cartridge 25. The fluidity of toners insider the toner cartridge 25 was studied while changing the angle within a range of 5 to 45 degrees with respect to the horizontal plane, as shown in FIG. 11. When the angle became 30 degrees or greater, the toners fell satisfactorily due to the dead weight. It is apparent from the results of the study that even in consideration of the vertical direction, the proper angle of the toner cartridge 25 would be about 45 degrees±15 degrees with respect to the gravitational direction. That is, the proper inclined angle of the toner cartridge 25 is 30 to 60 degrees with respect to the horizontal direction. More preferably, at 45 degrees±5 degrees, good results would be obtained.

Toners may stick inside the toner cartridge 25. To prevent this phenomenon, the inner walls of the toner cartridge 25 should have a low frictional coefficient. Therefore, fluoro-rubber or the like is coated on the inner walls of the toner cartridge 25.

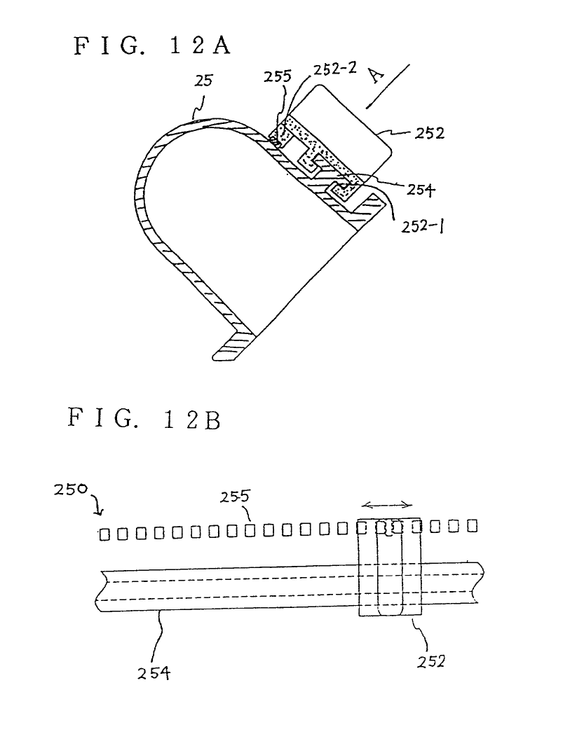

FIGS. 12A and 12B show the structure of a modification of the present invention.

In this example, a vibration member 250 is provided to prevent toners from sticking on the inner walls of the toner cartridge 25. The toner cartridge 25 is vibrated externally by the vibration member 250 to thereby forcibly drop the toners from the inner walls of the cartridge 25.

As shown in FIGS. 12A and 12B, the vibration member 250 has a row of projections 255 formed on the upper portion of the side of the toner cartridge 25, with a guide rail 254 located under the projections 255. The handle 252 has an engage block 252-1 which is to be fitted on the guide rail 254, and a projection block 252-2 which hits against the projections 252.

As shown in FIG. 12B, the handle 252 is moved along the guide rail 254 rightward and leftward in the diagram. This movement causes the projection block 252-2 to hit against the row of projections 255, thus vibrating the toner cartridge 25 up and down in FIG. 12A. As the toner cartridge 25 is externally vibrated in this manner, the toners sticking on the inner walls of the cartridge 25 are forced to drop.

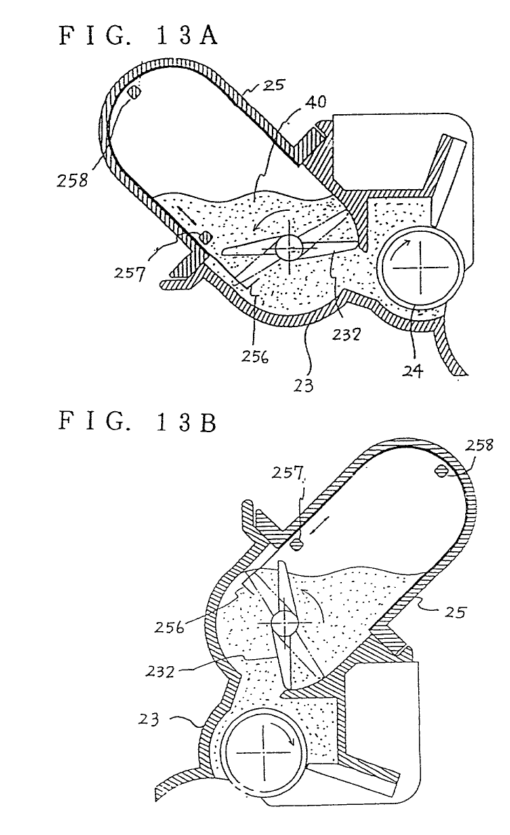

FIGS. 13A and 13B show the structure of another modification of the present invention.

In this modification, the toner cartridge 25 is also vibrated externally by the vibration member 250 to thereby forcibly drop the toners from the inner walls of the cartridge 25. As shown in FIG. 13A, a sheet 256 with a secured end is provided inside the toner cartridge 25. The other end of this sheet 256 is engaged with the toner supply roller 232 of the developing unit 23. The sheet 256 is guided by a pair of guides 257 and 258 along the inner walls of the toner cartridge 25.

As apparent from FIG. 13A showing the horizontal position and FIG. 13B the upright position, as the toner supply roller 232 rotates, the sheet 256 reciprocates along the lengthwise direction. This reciprocal motion vibrates the inner walls of the toner cartridge 25 to force the toners to fall from the inner walls of the cartridge 25.

The present invention may be modified in various other manners as follows.

First, although a 1.5-component developer having a combination of the magnetic carrier and magnetic polymerization toners is used as a developer in the above-described embodiment, magnetic pulverized toners may also be used as the magnetic toners. Secondly, although only the sleeves of the developing rollers 24 are rotated, the magnet rollers may also be rotated. Thirdly, although the LED optical system has been explained as an image exposing section, a laser optical system, a liquid crystal shutter optical system, an EL (electroluminescent) optical system and so forth may be used as well. Fourthly, although the image forming mechanism has been explained as an electrophotographing mechanism, another image forming mechanism (like an electrostatic recording mechanism) which transfers a toner image on a sheet may also be used, and sheets are not limited to paper but other types of media can be used as well. Further, the photosensitive body is not limited to a drum type, but may be of an endless belt type. Fifthly, although the present invention has been explained as a printing apparatus, it may be a different type of image forming apparatus, such as a copying machine or facsimile.

The present invention is not limited to the above-described embodiment, but may be modified in various forms without departing from the spirit and scope of the invention. Therefore, the present examples and embodiment are to be considered as illustrative and not restrictive and the invention is not to be limited to the details given herein, but may be modified within the scope of the appended claims.

In short, according to the present invention, the toner supplementing mechanism 25 is attached to the developing unit 23 with inclination to the gravitational direction. Whether the apparatus is set in a horizontal position or an upright position, therefore, the gravity will cause the toners in the toner supplementing mechanism 25 to fall into the developing unit 23 by the dead weight. In both horizontal and upright positions, this image forming apparatus will stably supplement toners and will thus accomplish stable image forming.

What is claimed is:

1. An image forming apparatus for forming an image on a sheet in both an upright position and a horizontal position, comprising:
a rotary endless latent image carrier;
image forming means for forming an electrostatic latent image on said latent image carrier;
developing means for developing said electrostatic latent image on said latent image carrier with a powdery developer;
toner supplementing means, attached to said developing means with inclination to a gravitational direction of said apparatus, for supplementing toners to said developing means; and
transfer means for transferring said developed image on said latent image carrier to a sheet.

2. The image forming apparatus according to claim 1, wherein said toner supplementing means is provided at said developing means at an inclined angle of 30 to 60 degrees with respect to said gravitational direction.

3. The image forming apparatus according to claim 1, wherein said toner supplementing means is a toner cartridge attachable to and detachable from said developing means.

4. The image forming apparatus according to claim 1, further having a layer for reducing a frictional coefficient of inner walls of said toner supplementing means.

5. The image forming apparatus according to claim 1, wherein said developing means has a developing room for retaining developer feeding means for feeding a developer to said latent image carrier, and a toner supply room where said toner supplementing means is attached to supply toners to said developing room.

6. The image forming apparatus according to claim 1, further comprising a vibration member, provided at said toner supplementing means, for vibrating said toner supplementing means.

7. The image forming apparatus according to claim 6, wherein said vibration member has a rail laid on said toner supplementing means, a lever movable along said rail, and a row of projections provided in parallel to said rail and contactable with said lever.

8. The image forming apparatus according to claim 6, wherein said vibration member is a sheet provided along inner walls of said toner supplementing means, and has one end engageable with a paddling member of said developing means.

9. The image forming apparatus according to claim 2, wherein said toner supplementing means is a toner cartridge attachable to and detachable from said developing means.

10. The image forming apparatus according to claim 2, further having a layer for reducing a frictional coefficient of inner walls of said toner supplementing means.

11. The image forming apparatus according to claim 2, wherein said developing means has a developing room for retaining developer feeding means for feeding a developer to said latent image carrier, and a toner supply room where said toner supplementing means is attached to supply toners to said developing room.

12. The image forming apparatus according to claim 2, further comprising a vibration member, provided at said toner supplementing means, for vibrating said toner supplementing means.

13. The image forming apparatus according to claim 12, wherein said vibration member has a rail laid on said toner supplementing means, a lever movable along said rail, and a row of projections provided in parallel to said rail and contactable with said lever.

14. The image forming apparatus according to claim 12, wherein said vibration member is a sheet provided along inner walls of said toner supplementing means, and has one end engageable with a paddling member of said developing means.

15. The image forming apparatus according to claim 3, further having a layer for reducing a frictional coefficient of inner walls of said toner supplementing means.

16. The image forming apparatus according to claim 3, wherein said developing means has a developing room for retaining developer feeding means for feeding a developer to said latent image carrier, and a toner supply room where said toner supplementing means is attached to supply toners to said developing room.

17. The image forming apparatus according to claim 3, further comprising a vibration member, provided at said toner supplementing means, for vibrating said toner supplementing means.

18. The image forming apparatus according to claim 17, wherein said vibration member has a rail laid on said toner supplementing means, a lever movable along said rail, and a row of projections provided in parallel to said rail and contactable with said lever.

19. The image forming apparatus according to claim 17, wherein said vibration member is a sheet provided along inner walls of said toner supplementing means, and has one end engageable with a paddling member of said developing means.

20. The image forming apparatus according to claim 4, wherein said developing means has a developing room for retaining developer feeding means for feeding a developer to said latent image carrier, and a toner supply room where said toner supplementing means is attached to supply toners to said developing room.

21. The image forming apparatus according to claim 5, further comprising a vibration member, provided at said toner supplementing means, for vibrating said toner supplementing means.

22. The image forming apparatus according to claim 21, wherein said vibration member has a rail laid on said toner supplementing means, a lever movable along said rail, and a row of projections provided in parallel to said rail and contactable with said lever.

23. The image forming apparatus according to claim 21, wherein said vibration member is a sheet provided along inner walls of said toner supplementing means, and has one end engageable with a paddling member of said developing means.

24. An image forming apparatus for forming an image on a sheet, comprising:
a rotary endless latent image carrier;
image forming means for forming an electrostatic latent image on said latent image carrier;
developing means for developing said electrostatic latent image on said latent image carrier with a powdery developer;
toner supplementing means, attached to said developing means with an inclined angle of 30 to 60 degrees with respect to a gravitational direction of said apparatus, for supplementing toners to said developing means; and
transfer means for transferring said developed image on said latent image carrier to a sheet.

25. The image forming apparatus according to claim 24, wherein said toner supplementing means is a toner cartridge attachable to and detachable from said developing means.

26. The image forming apparatus according to claim 24, further having a layer for reducing a frictional coefficient of inner walls of said toner supplementing means.

27. The image forming apparatus according to claim 24, wherein said developing means has a developing room for retaining developer feeding means for feeding a developer to said latent image carrier, and a toner supply room where said toner supplementing means is attached to supply toners to said developing room.

28. The image forming apparatus according to claim 24, further comprising a vibration member, provided at said toner supplementing means, for vibrating said toner supplementing means.

29. The image forming apparatus according to claim 28, wherein said vibration member has a rail laid on said toner supplementing means, a lever movable along said rail, and a row of projections provided in parallel to said rail and contactable with said lever.

30. The image forming apparatus according to claim 28, wherein said vibration member is a sheet provided along inner walls of said toner supplementing means, and has one end engageable with a paddling member of said developing means.
